(19) United States
(12) Patent Application Publication
(10) Pub. No.: US 2015/0310092 A1
(43) Pub. Date: Oct. 29, 2015

(54) ATTRIBUTE HISTOGRAMS FOR PROVIDING DATA ACCESS

(71) Applicant: MICROSOFT CORPORATION, Redmond, WA (US)

(72) Inventors: YUN SHI, Redmond, WA (US); ANAND EDWIN, Bellevue, WA (US); VINAY KUMAR, Bellevue, WA (US); SRIVENKATARAMAN SRIKUMARASWAMI, Bellevue, WA (US)

(73) Assignee: MICROSOFT CORPORATION, Redmond, WA (US)

(21) Appl. No.: 14/263,723

(22) Filed: Apr. 28, 2014

(51) Int. Cl. G06F 17/30; G06Q 30/02

(52) U.S. Cl. CPC G06F 17/30601; G06Q 30/0277

(57) ABSTRACT

Systems, methods, and computer-readable storage media are provided for providing a view into a mass of data when the number of items that make up the mass is very large. A request for display of information about a subset of data items contained within the corpus that have a specified characteristic is received. A quantity of data items comprising the subset is determined. It also is determined whether the quantity exceeds a threshold. If the quantity does not exceed the threshold, the requested information is presented. If, however, the quantity of data items comprising the subset exceeds the threshold, a view of the data items comprising the subset is provided that includes at least one distribution graph (e.g., histogram) generated in view of a certain measure, each distribution graph showing a visual representation of the data items comprising the subset organized by a particular attribute.

### BACKGROUND

Modern data stores often contain vast amounts of information organized such that it is accessible in a multitude of different ways. For instance, data stores may contain data items organized, for instance, via hierarchies or tagging strategies, into many categories, sub-categories, and the like. Such organization enables users to inquire and receive detailed information about subsets of the data items of interest to them in a simpler manner than is possible with an unorganized data corpus.

However, as the amount of information contained within a data store increases, the quantity of data items satisfying a given inquiry may exceed a manageable number, for instance, due to technical and infrastructural limitations. When this happens, the user is often simply notified that the number of satisfying data items is too large and requested to provide a more narrowed inquiry. An exemplary view that may be displayed in such a situation is illustrated in the schematic diagram of FIG. 1. Not only does the user in such circumstances not receive the detailed information they are looking for, but they receive a complete lack of meaningful information as a result of their inquiry which can be frustrating.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for providing a meaningful view into a corpus of data when the number of data items that make up the corpus is very large. A request for display of information about a subset of data items contained within the corpus that have a specified characteristic is received. A quantity of data items comprising the subset is determined. It also is determined whether the number exceeds a threshold number. If the quantity does not exceed the threshold, the requested information is presented. If, however, it is determined that the quantity of data items comprising the subset exceeds the threshold, a view of the data items comprising the subset is provided that includes at least one distribution graph generated in view of a certain measure, each distribution graph showing a visual representation of the data items comprising the subset organized by a particular attribute.

### BRIEF DESCRIPTION OF THE DRAWINGS

The present invention is illustrated by way of example and not limitation in the accompanying figures in which like reference numerals indicate similar elements and in which:

FIG. 1 is a schematic diagram illustrating an exemplary prior art view that may be displayed when the number of data items satisfying a request for detailed information exceeds a threshold number;

FIG. 2 is a block diagram of an exemplary computing environment suitable for use in implementing embodiments of the present invention;

FIG. 3 is a block diagram of an exemplary computing system in which embodiments of the invention may be employed;

FIG. 4 is a schematic diagram illustrating an exemplary view that may be displayed when the number of data items satisfying a request for detailed information exceeds a threshold number, the view including four exemplary attribute histograms or distribution graphs, in accordance with an embodiment of the present invention;

FIG. 5 is a schematic diagram illustrating an exemplary view that may be displayed when the number of data items satisfying a request has been altered via user interaction with the display of FIG. 4 but the number of satisfying data items continues to exceed the threshold number, in accordance with an embodiment of the present invention;

FIG. 6 is a schematic diagram illustrating an exemplary view that may be displayed when the number of data items satisfying a request for detailed information has been altered via user interaction with either the display of FIG. 4 or the display of FIG. 5 and the number of satisfying data items no longer exceeds the threshold number, in accordance with an embodiment of the present invention;

FIGS. 7A, 7B, and 7C are schematic diagrams illustrating an exemplary user flow and exemplary business logic that may be utilized in accordance with embodiments of the present invention;

FIG. 8 is a schematic diagram illustrating latency compensation in accordance with embodiments of the present invention;

FIG. 9 is a flow diagram showing an exemplary method for providing access to a subset of data items included in a large data corpus, the data items comprising the subset each having a specified characteristic, in accordance with an embodiment of the present invention;

FIG. 10 is a flow diagram showing an exemplary method for providing access to a subset of online advertising data as an example of a large data corpus, in accordance with an embodiment of the present invention; and

FIG. 11 is a flow diagram showing another exemplary method for providing access to a subset data items included in a large data corpus, the data items comprising the subset each having a specified characteristic, in accordance with an embodiment of the present invention.

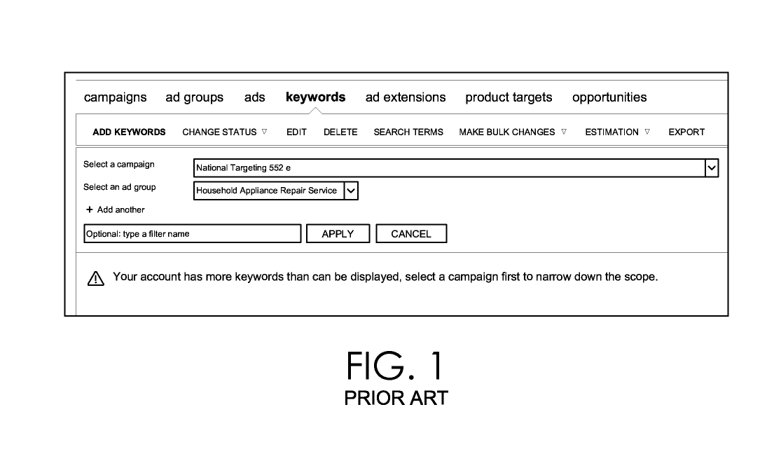

### DETAILED DESCRIPTION

The subject matter of the present invention is described with specificity herein to meet statutory requirements. However, the description itself is not intended to limit the scope of this patent. Rather, the inventors have contemplated that the claimed subject matter also might be embodied in other ways, to include different steps or combinations of steps similar to the ones described in this document, in conjunction with other present or future technologies. Moreover, although the terms “step,” “block,” and/or “component,” etc., may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for providing a meaningful view into a corpus of data when the number of data items that make up the corpus is very large. By way of example only, the corpus may be an online advertising database that contains information regarding advertising campaigns and their respective performance for a number of advertisers. By way of another example, the corpus may be associated with a retail establishment or a plurality of retail establishments and contain information regarding orders, inventories, and the like.

In accordance with embodiments of the present invention, a request for display of information about a subset of data items contained within the corpus that have a specified characteristic is received. For instance, in the exemplary online advertising data corpus, a request may be received for the display of information about data items associated with a particular advertising account. Or, in the exemplary retail database, a request may be received for the display of information about items bearing a particular brand name.

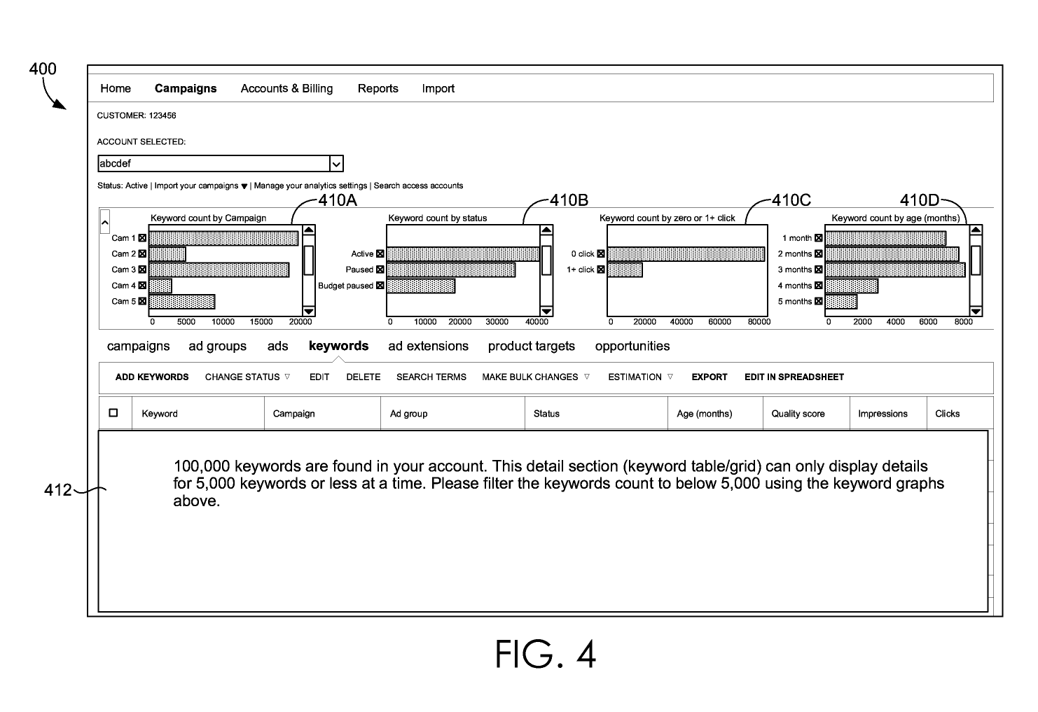

A quantity of data items comprising the subset is determined. It also is determined whether the quantity exceeds a threshold number. If the quantity does not exceed the threshold, the requested information is presented. If, however, it is determined that the quantity of data items comprising the subset exceeds the threshold, a view of the data items having the specified characteristic is provided that includes at least one distribution graph generated in view of a certain measure, each distribution graph showing a visual representation of the data items having the specified characteristic organized by a particular attribute. For instance, in the exemplary advertising data corpus, a view may be provided showing a plurality of graphs illustrating the distribution of data items that are associated with the specified advertising account (the specified characteristic) generated in view of keyword counts (the measure in view of which the graphs are generated), each graph showing a visual representation of those satisfying data items organized by attributes such as campaign, status, age, impressions, clicks, and the like. An example of the systems and methods described herein utilizing an advertising data corpus is more fully described below with reference to FIGS. 4-8 and 10.

By way of another example, the exemplary retail data corpus mentioned above, a view may be provided showing a plurality of graphs illustrating the distribution of data items that are associated with the particular brand name (the specified characteristic) generated in view of inventory (the measure in view of which the graphs are generated), each graph showing a visual representation of those satisfying data items organized by attributes such as retail store location, item number, item descriptor, color, and the like.

Accordingly, one embodiment of the present invention is directed to one or more computer-readable storage media storing computer-useable instructions that, when used by one or more computing devices, cause the one or more computing devices to perform a method for providing access to data. The method comprises receiving a request for display of information about a plurality of data items, each of the plurality of data items having a specified characteristic; determining that a quantity of the plurality of data items having the specified characteristic exceeds a threshold number; and providing a view of the plurality of data items having the specified characteristic that includes at least one distribution graph generated in view of a certain measure. Each of the at least one distribution graphs shows a visual representation of the plurality of data items having the specified characteristic organized by a particular attribute.

In another embodiment, the present invention is directed to a method being performed by one or more computing devices including at least one processor, the method for providing access to online advertising data. The method includes receiving a request for display of information about a plurality of keywords, each of the plurality of keywords having a specified characteristic. The method further includes determining that a quantity of the plurality of keywords having the specified characteristic exceeds a threshold number, and providing a view of the plurality of keywords having the specified characteristic that includes at least one distribution graph generated in view of keyword count. Each at least one distribution graph illustrates a visual representation of the plurality of keywords having the specified characteristic organized by a particular attribute.

In yet another embodiment, the present invention is directed to a system including a server having one or more processors and one or more computer-readable storage media, and a data store coupled with the server. The server is configured to receive a request for presentation of information about a plurality of data items, each of the plurality of data items having a specified characteristic; determine that a quantity of the plurality of data items having the specified characteristic exceeds a threshold number; provide a visual indication that the requested information cannot be displayed because the number of the plurality of data items having the specified characteristic exceeds the threshold number; and provide a view of the plurality of data items having the specified characteristic that includes plural distribution graphs each generated in view of a certain measure and each showing a visual representation of the plurality of data items having the specified characteristic organized by a different particular attribute than any other of the plurality of distribution graphs.

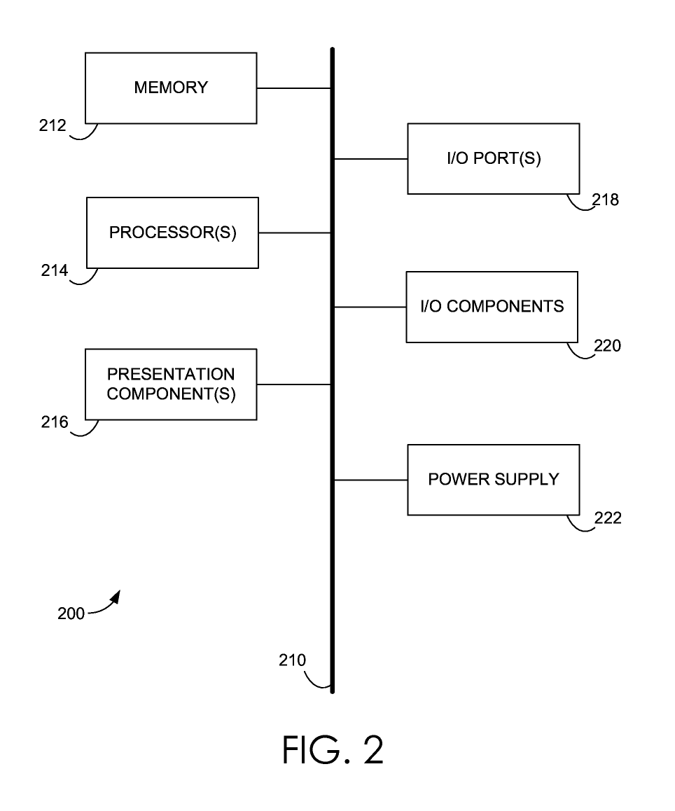

Having briefly described an overview of embodiments of the present invention, an exemplary operating environment in which embodiments of the present invention may be implemented is described below in order to provide a general context for various aspects of the present invention. Referring to the figures in general and initially to FIG. 2 in particular, an exemplary operating environment for implementing embodiments of the present invention is shown and designated generally as computing device 200. The computing device 200 is but one example of a suitable computing environment and is not intended to suggest any limitation as to the scope of use or functionality of embodiments of the invention. Neither should the computing device 200 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

As utilized herein, the phrase “computing device” generally refers to a dedicated computing device with processing power and storage memory, which supports operating software that underlies the execution of software, applications, and computer programs thereon. As one skilled in the art will appreciate, the computing device 200 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs).

With continued reference to FIG. 2, the computing device 200 includes a bus 210 that directly or indirectly couples the following devices: a memory 212, one or more processors 214, one or more presentation components 216, one or more input/output (I/O) ports 218, one or more I/O components 220, and an illustrative power supply 222. The bus 210 represents what may be one or more busses (such as an address bus, data bus, or combination thereof). Although the various blocks of FIG. 2 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 2 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 2 and reference to “computer” or “computing device.”

The computing device 200 typically includes a variety of computer-readable media. Computer-readable media may be any available media that is accessible by the computing device 200 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 200. In an embodiment, the computer storage media can be selected from tangible computer storage media like flash memory. These memory technologies can store data momentarily, temporarily, or permanently. Computer storage does not include and excludes communication media.

Communication media, on the other hand, typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 212 includes computer-storage media in the form of volatile and/or nonvolatile memory. The memory may be removable, non-removable, or a combination thereof. Exemplary hardware devices include solid-state memory, hard drives, optical-disc drives, and the like. The computing device 200 includes one or more processors that read data from various entities such as the memory 212 or the I/O components 220. The presentation component(s) 216 present data indications to a user or other device. Exemplary presentation components include a display device, speaker, printing component, vibrating component, and the like.

The I/O ports 218 allow the computing device 200 to be logically coupled to other devices including the I/O components 220, some of which may be built in. Illustrative components include a microphone, joystick, game pad, satellite dish, scanner, printer, wireless device, a controller (such as a stylus, keyboard, and mouse) or a natural user interface (NUI), etc.

A NUI processes gestures (e.g., hand, face, body, etc.), voice, or other physiological inputs generated by a user. These inputs may be interpreted, for instance, as requests for information, requests to alter displays in accordance with particular instructions, or the like. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 200. The computing device 200 may be equipped with depth cameras, such as stereoscopic camera systems, infrared camera systems, RGB camera systems, and combinations of these, for gesture detection and recognition. Additionally, the computing device 200 may be equipped with accelerometers or gyroscopes that enable detection of motion. The output of the accelerometers or gyroscopes may be provided to the display of the computing device 200 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein also may be practiced in distributed computing environments where tasks are performed by remote processing devices that are linked through a communications network. In a distributed computing environment, program modules may be located in both local and remote computer storage media including memory storage devices.

Furthermore, although the term “server” is used herein, it will be recognized that this term also may encompass a search engine, a Web browser, a set of one or more processes distributed on one or more computers, one or more stand-alone storage devices, a set of one or more other computing or storage devices, a combination of one or more of the above, and the like.

As previously mentioned, embodiments of the present invention are generally directed to systems, methods, and computer-readable storage media for providing a meaningful view into a corpus of data when the number of data items that make up the corpus is very large. A request for display of information about a subset of data items contained within the corpus that have a specified characteristic is received. A quantity of data items comprising the subset is determined. It also is determined whether the quantity exceeds a threshold number. If the quantity does not exceed the threshold, the requested information is presented. If, however, it is determined that the quantity of data items comprising the subset exceeds the threshold, a view of the data items having the specified characteristic is provided that includes at least one distribution graph (e.g., a histogram) generated in view of a certain measure, each distribution graph showing a visual representation of the data items comprising the subset organized by a particular attribute.

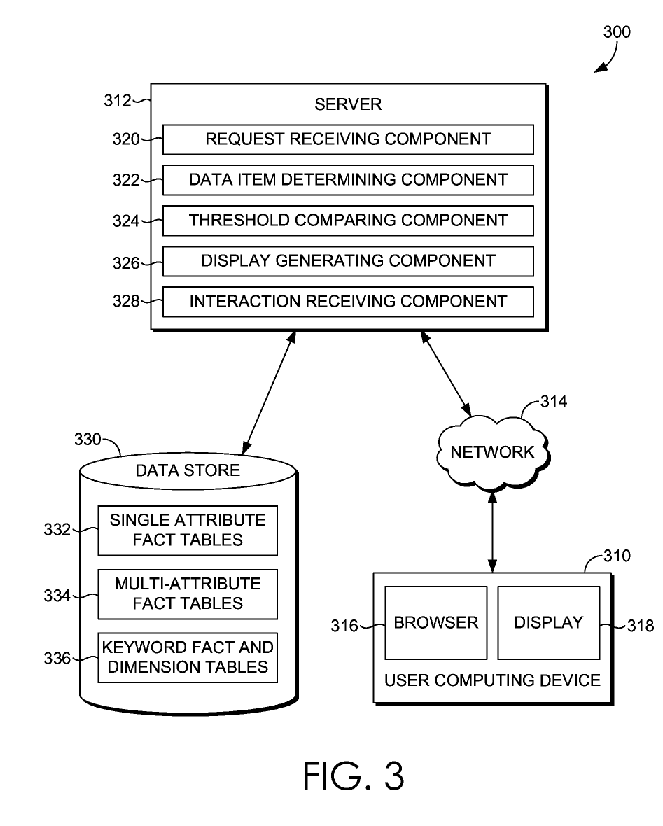

Referring now to FIG. 3, a block diagram is provided illustrating an exemplary computing system 300 in which embodiments of the present invention may be employed. Generally, the computing system 300 illustrates an environment in which a meaningful view into a mass of data may be provided when the number of data items that make up the mass is very large. Among other components not shown, the computing system 300 generally includes a user computing device 310 and a server 312 in communication with one another via a network 314. The network 314 may include, without limitation, one or more local area networks (LANs) and/or wide area networks (WANs). Such networking environments are commonplace in offices, enterprise-wide computer networks, intranets and the Internet. Accordingly, the network 314 is not further described herein.

It should be understood that any number of user computing devices 310 and/or servers 312 may be employed in the computing system 300 within the scope of embodiments of the present invention. Each may comprise a single device/interface or multiple devices/interfaces cooperating in a distributed environment. For instance, the server 312 may comprise multiple devices and/or modules arranged in a distributed environment that collectively provide the functionality of the server 312 described herein. Additionally, other components or modules not shown also may be included within the computing system 300.

In some embodiments, one or more of the illustrated components/modules may be implemented as stand-alone applications. In other embodiments, one or more of the illustrated components/modules may be implemented via the user computing device 310, the server 312, or as an Internet-based service. It will be understood by those of ordinary skill in the art that the components/modules illustrated in FIG. 3 are exemplary in nature and in number and should not be construed as limiting. Any number of components/modules may be employed to achieve the desired functionality within the scope of embodiments hereof. Further, components/modules may be located on any number of servers and/or user computing devices. By way of example only, the server 312 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 310 may include any type of computing device, such as the computing device 200 described with reference to FIG. 2, for example. Generally, the user computing device 310 includes a browser 316 and a display 318. The browser 316, among other things, is configured to render search engine home pages (or other online landing pages) and search engine results pages (SERPs), in association with the display 318 of the user computing device 310. The browser 316 further is configured to receive user input of requests for various web pages (including search engine home pages), receive user input search queries (generally input via a user interface presented on the display 318 and permitting alpha-numeric and/or textual input into a designated search input region) and to receive content for presentation on the display 318, for instance, from the server 312. It should be noted that the functionality described herein as being performed by the browser 316 may be performed by any other application, application software, user interface, or the like capable of rendering Web content. It should further be noted that embodiments of the present invention are equally applicable to mobile computing devices and devices accepting touch and/or voice input. Any and all such variations, and any combination thereof, are contemplated to be within the scope of embodiments of the present invention.

The server 312 of FIG. 3 is configured, among other things, to receive requests for presentation of information about data items included in a large data corpus and determine whether the requested information may be displayed. The server 312 additionally is configured, among other things, to provide a meaningful view into the data items satisfying the request even when the specific requested information cannot be displayed, for instance, due to processing constraints. As illustrated, the server 312 includes a request receiving component 320, a data item determining component 322, a threshold comparing component 324, a display generating component 326, and an interaction receiving component 328. The illustrated search engine 312 also has access to a data store 330. The data store 330 is configured to store any desired information related to data items included in a large data corpus, such information being organized as, by way of example only, single attribute fact tables 332, multi-attribute fact tables 334, and keyword fact and dimension tables 336. Each of these structures for data organization and potential uses there for in accordance with embodiments hereof is more fully described below.

In embodiments, the data store 338 is configured to be searchable for one or more of the data items stored in association therewith. It will be understood and appreciated by those of ordinary skill in the art that the information stored in association with the data store 338 may be configurable and may include any information relevant to data items and their respective organizational components. The content and volume of such information are not intended to limit the scope of embodiments of the present invention in any way. Further, though illustrated as a single, independent component, the data store 338 may, in fact, be a plurality of storage devices, for instance a database cluster, portions of which may reside in association with the server 312, the user computing device 310, another external computing device (not shown), and/or any combination thereof.

The request receiving component 320 of the server 312 is configured to receive requests for information about a plurality of data items having a specified characteristic, each of the data items being included, for instance, in the data store 330. Such requests may be received, by way of example only, via the user computing device 310 through the network 314. For purposes of illustration only, suppose the data store 330 includes online advertising data items for a number of advertisers and that the request receiving component 320 receives a request from an advertiser associated with Customer Number 123456 for data items associated with Account “abcdef” (the specified characteristic).

Upon the request receiving component 320 receiving the request for detailed information about the plurality of data items having the specified characteristic, the data item determining component 322 of the server 312 is configured to query a data store (e.g., the data store 230) and determine the number of data items that comprise the requested data item subset, that is, to determine the number of data items satisfying the request. Armed with the number of request-satisfying data items, the threshold comparing component 324 of the server 312 is configured to compare the number of request-satisfying data items to a threshold number of data items for which the desired information may be displayed. The threshold number may be preconfigured and determined arbitrarily, due to processing constraints, or in any other desired manner within the scope of embodiments of the present invention.

If it is determined by the threshold comparing component 324 that the number of request-satisfying data items does not exceed the threshold number, the display generating component 326 of the server 312 is configured to generate a display that includes the requested information, the display to be presented, for instance, in association with the display 318 of the user computing device 310. If, however, it is determined by the threshold comparing component 324 that the number of request-satisfying data items exceeds the threshold number, the display generating component 326 is configured to generate a display that includes at least one distribution graph (e.g., histogram) generated in view of a certain measure, the at least one distribution graph showing a visual representation of the request-satisfying data items organized by a particular attribute. In embodiments, the display generating component 326 further is configured to generate, as part of the display, a visual indication that the requested detailed information cannot be displayed because the number of request-satisfying data items exceeds the threshold number.

With reference to FIG. 4, and following the example above wherein a request from an advertiser associated with Customer Number 123456 for data items associated with Account “abcdef” is received, a schematic diagram is shown illustrating an exemplary view 400 that may be displayed when the number of data items satisfying the request exceeds a threshold number, the view including four exemplary attribute histograms or distribution graphs 410a, 410b, 410c, 410d, in accordance with an embodiment of the present invention. In the illustrated view, each of the four distribution graphs 410a, 410b, 410c, 410d is generated in view of keyword count (the certain measure) and each shows a visual representation of the request-satisfying data items organized by a particular attribute, i.e., “Campaign” (410a), “status” (410b), “zero or 1+ click” (410c), and “age (months)” (410d). The distribution graphs for each attribute include a plurality of attribute values which aid in quickly and visually providing meaningful insight into the request-satisfying data items. For instance, the distribution graph for “Keyword count by Campaign” 410a includes attribute values for campaign 1 (“Cam 1”), campaign 2 (“Cam 2”), campaign 3 (“Cam 3”), campaign 4 (“Cam 4”), and campaign 5 (“Cam 5”). The distribution graph for “Keyword count by status” 410b includes attribute values for active keywords, paused keywords, and keywords paused for budget reasons. The distribution graph for “Keyword count by zero or 1+ click” 410c includes attribute values for zero clicks and one or more clicks. And the distribution graph for “Keyword count by age (months)” 410d includes attribute values for one month, two months, three months, four months and five months.

Within each distribution graph 410a, 410b, 410c, 410d, a graphical illustration of the number of keywords having each attribute value is shown by way of a shaded rectangle, the horizontal length of which corresponds to the keyword count in accordance with the scale shown just beneath the respective graph. In this way, users may readily and meaningfully view those attribute/attribute value combinations that provide the highest number of request-satisfying keywords. It will be understood and appreciated by those of ordinary skill in the art that the illustrated graphical representation is by way of example only and that any manner of visually providing comparative information among attribute values within a particular distribution graph may be utilized in accordance with embodiments of the present invention.

Also illustrated in the view of FIG. 4 is a visual indication 412 that the requested information cannot be displayed due the number of request-satisfying data items. The user further is requested to filter the keyword count to below the threshold number (5,000 in the illustrated view) using the distribution graphs.

Returning now to FIG. 3, the interaction receiving component 328 of the server 312 is configured to receive user interactions associated with receiving desired information related to data items contained within a data store, for instance, the data store 330. In this regard, the interaction receiving component 328 is configured to receive user interactions associated with specified characteristics of data items for which detailed information is desired. The interaction receiving component 328 further is configured to receive user interactions with presented distribution graphs, such interactions generally being received with intent to alter the quantity of request-satisfying data items, for instance, to bring the quantity to below the threshold number so that the desired detailed information may be displayed.

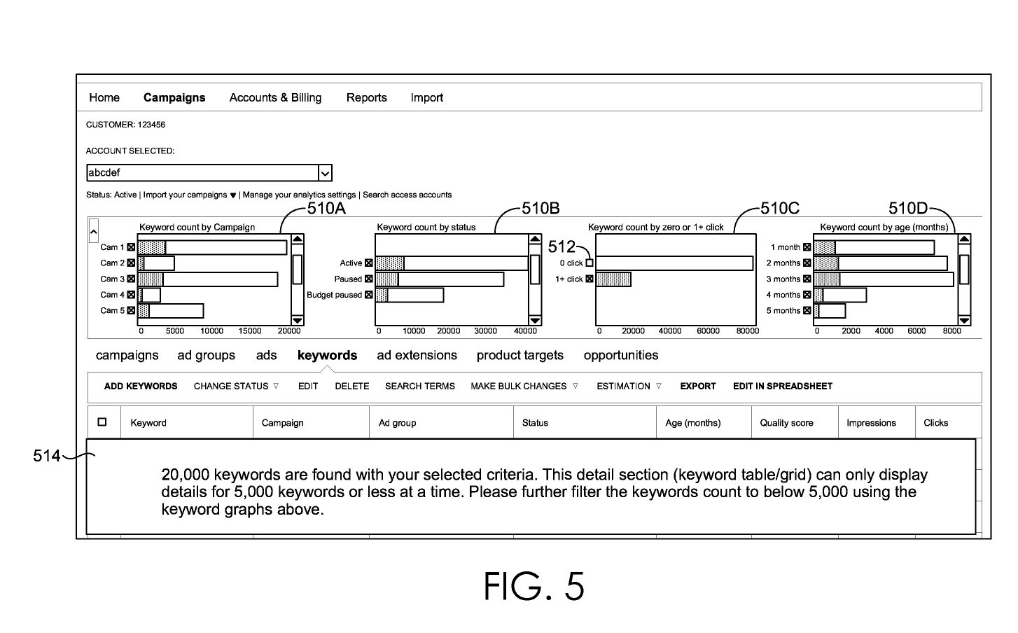

With reference to FIG. 5, and continuing with the example above wherein a request from an advertiser associated with Customer Number 123456 for data items associated with Account “abcdef” is received, a schematic diagram is shown illustrating an exemplary view that may be displayed when the number of data items satisfying a request has been altered via user interaction with the display of FIG. 4, in accordance with an embodiment of the present invention. The distribution graph for “Keyword count by zero or 1+ click” 510c has been altered by user interaction with and de-selection of the selection box 512 appearing next to the attribute value “0 click” (such interaction being received, e.g., by the interaction receiving component 328 of FIG. 3). By virtue of this interaction, keywords otherwise satisfying the originally requested criteria are removed from the subset of keywords for which information now is requested.

Each of the displayed distribution graphs 510a, 510b, 510c, 510d has been altered as a result of the user interaction with the “Keyword count by zero or 1+ click” graph 510c such that rectangular shading remains representing the number of keywords satisfying each attribute value but with the representative quantities now being determined based upon the altered criteria (i.e., removing any previously satisfying results that were associated with zero clicks). An outline of the original rectangular shading remains, however, to illustrate the change in a meaningful and insightful manner.

In the illustrated example, the user's interaction has lowered the number of keywords from the 100,000 that were identified in the view of FIGS. 4 to 20,000. However, this number is still above the threshold number of 5,000 for which the requested information may be displayed. Thus, also presented is a message 514 indicating such and requesting that the user further filter by interacting with the presented keyword distribution graphs 510a, 510b, 510c, 510d (such interaction being received by, for instance, the interaction receiving component 328 of FIG. 2).

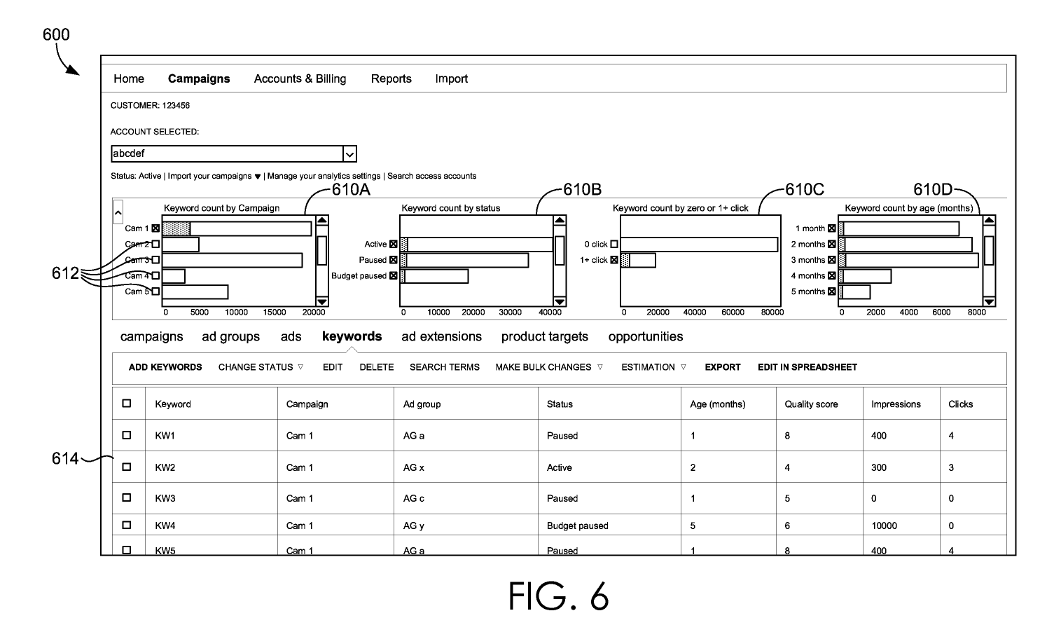

Turning now to FIG. 6, a schematic diagram is shown illustrating an exemplary view 600 that may be displayed when the number of data items satisfying a request for detailed information has been altered via user interaction with the display of FIG. 5 and the number of satisfying data items no longer exceeds the threshold number, in accordance with an embodiment of the present invention. In the illustrated view, the user has deselected the selection boxes 612 associated with each of the attribute values “Cam 2,” “Cam 3,” “Cam 4,” and “Cam 5” in the “Keyword count by Campaign” attribute distribution graph 610a, thus reducing the number of keywords satisfying the request for information to a number below the threshold number. Thus, instead of a message indicating the number of satisfying keywords is above the threshold as had previously been presented in association with the views of FIGS. 4 and 5, the requested information 614 is now presented for the satisfying keywords. Note that the view of FIG. 6 also could have been arrived at by interaction with the view of FIG. 4 upon user de-selection of the selection boxes associated with the “0 click” attribute value of the “Keyword count by zero or 1+ click” distribution graph 410c and the “Cam 2,” “Cam 3,” “Cam 4,” and “Cam 5” attribute value selection boxes of the “Keyword count by Campaign” attribute distribution graph 410a.

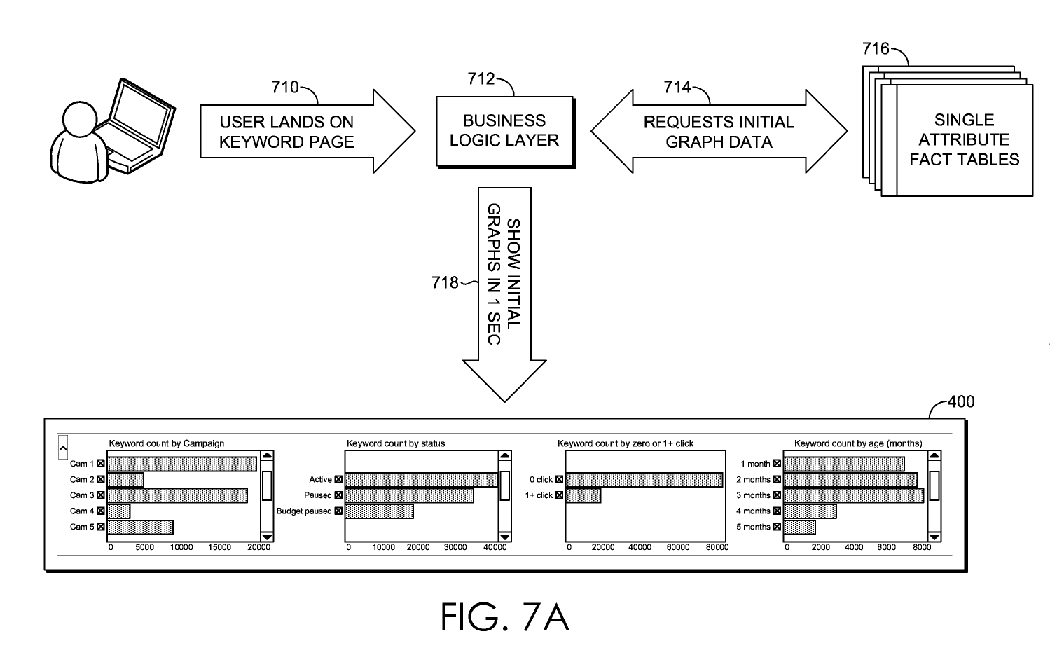

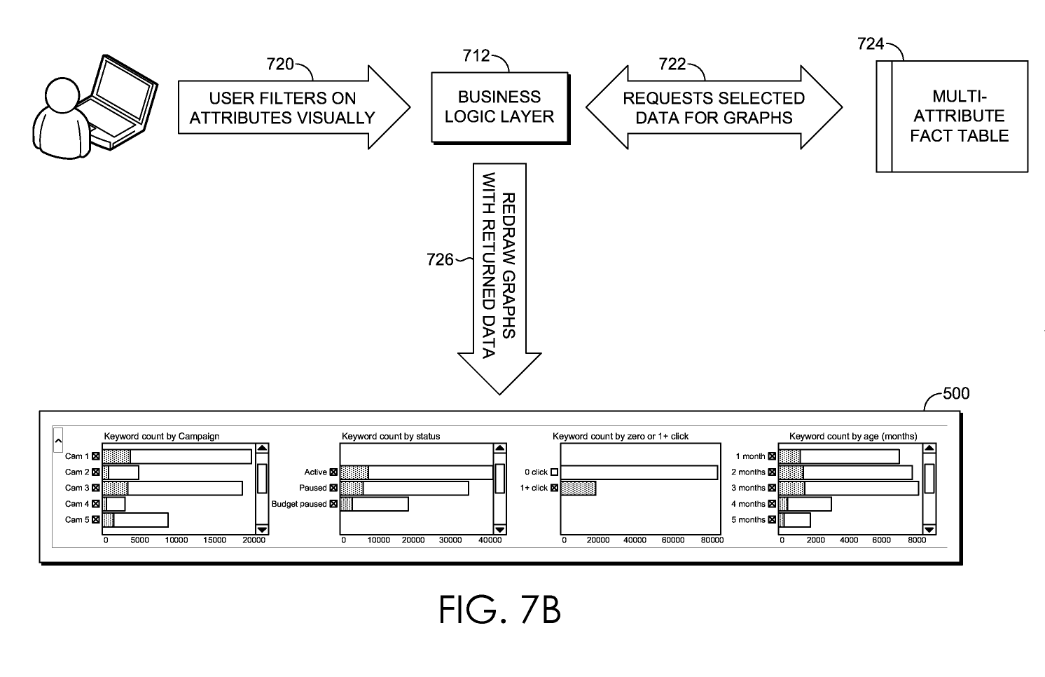

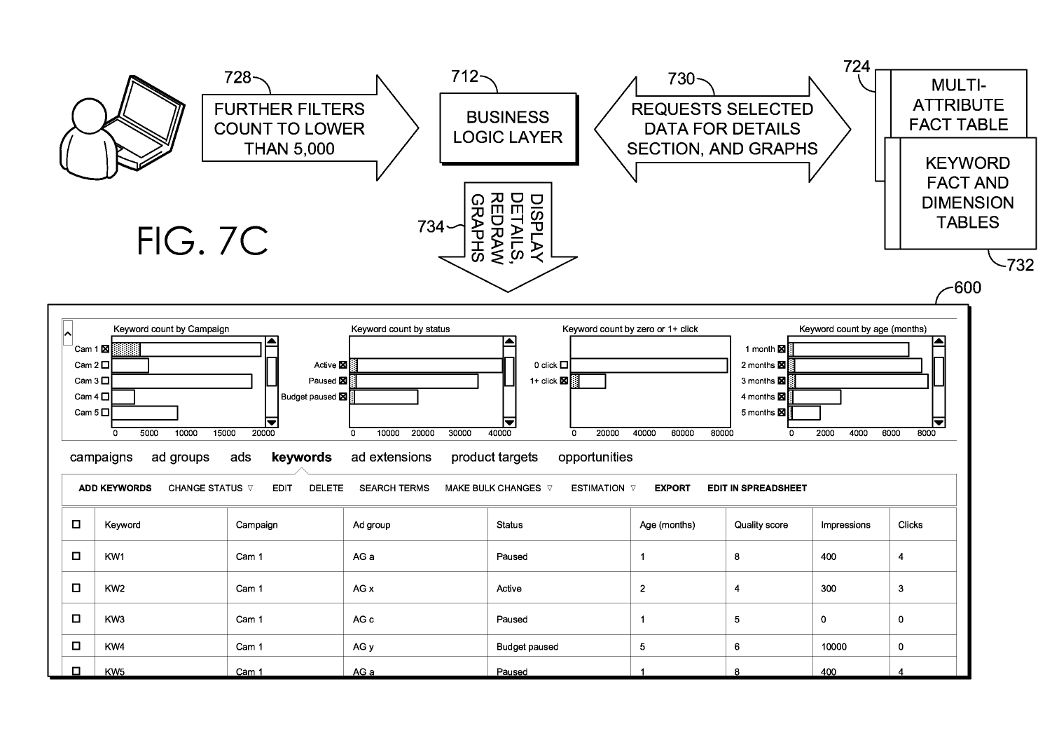

With reference now to FIGS. 7A, 7B, and 7C, schematic diagrams are shown illustrating an exemplary user flow and exemplary business logic that may be utilized in accordance with embodiments of the present invention to arrive at the views illustrated and described above with reference to FIGS. 4, 5 and 6. Initially, a user lands on the keyword page 710 (that is, an online landing page from which information about a subset of data contained within a large corpus of data may be requested). The request is sent to a business logic layer 712 which requests the initial graph data from a data store 714. Specifically, single attribute fact tables 716 (e.g., the single attribute fact tables 332 illustrated in the data store 330 of FIG. 3) are queried. The initial graph data is returned to the business logic layer 712 and the initial view is quickly rendered 718, for instance, in no more than one second. This initial graph data is displayed 400. (A more detailed and complete view of the display is described with reference to FIG. 4.)

Turning to FIG. 7B, the user filters on one or more of the attributes 720 in an attempt to alter the quantity of request-satisfying data items to a level below the threshold number. This request is sent to the business logic layer 712 which requests the altered data from the data store 722. Specifically in this instance, multi-attribute fact tables 724 are queried (e.g., the multi-attribute fact tables 334 illustrated in the data store 330 of FIG. 3). The altered graph data is returned to the business logic layer 712 and the altered view is rendered 726. This altered graph data is displayed 500. (A more detailed and complete view of the display is described with reference to FIG. 5.)

With reference to FIG. 7C, the user further filters on one or more of the attributes 728 to lower the quantity of request-satisfying data items to a level below the threshold number (in this case 5,000). This request is sent to the business logic layer 712 which requests the selected data for graphs (multi-attribute fact tables 724 are queried) and the requested detailed information (keyword fact and dimension tables 732 are queried, for instance, keyword fact and dimension tables 336 of the data store 330 of FIG. 2). The further altered graph data and detailed information are returned to the business logic layer 712 and the detailed view and further altered graphs are rendered 734. The rendered information is displayed 600. (A more detailed and complete view of the display is described with reference to FIG. 6).

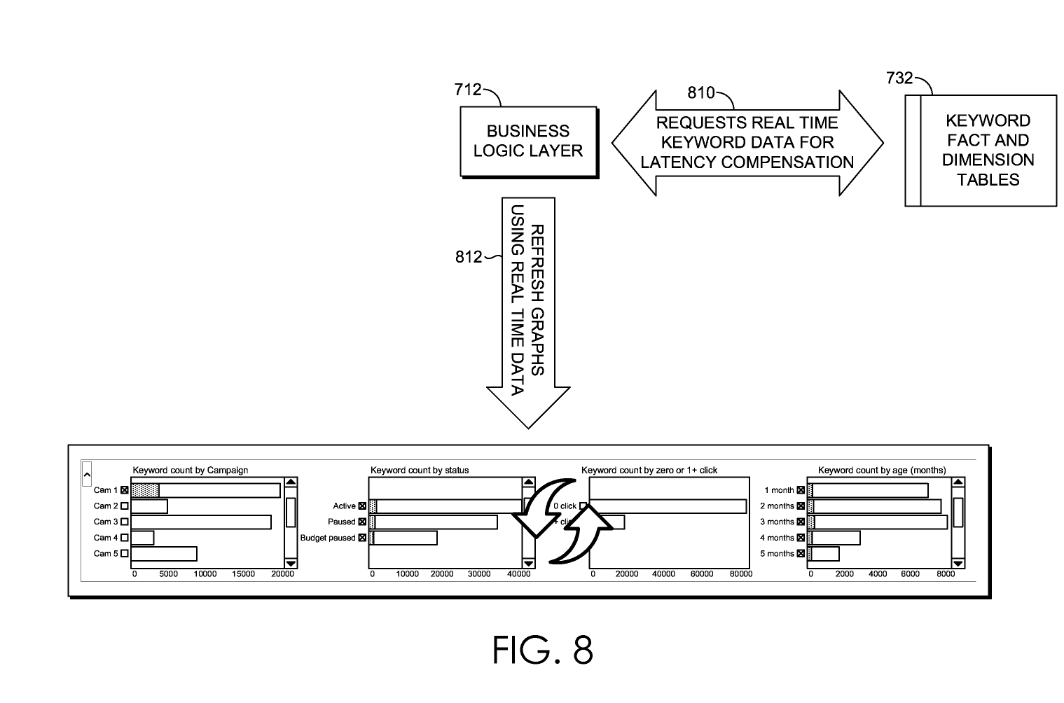

In accordance with embodiments of the present invention, real-time or near real-time changes in the data may be reflected in the rendered graphs and/or detailed information. This is illustrated in the schematic view of FIG. 8. The business logic layer 712 discussed with reference to FIG. 7, requests real-time data for latency compensation 810 from the keyword fact and dimension tables 732. Changes and/or updates are returned to the business logic layer 712 and the graphs are refreshed 812 on a frequent and consistent basis to insure that the data being observed by the user is fresh and relevant.

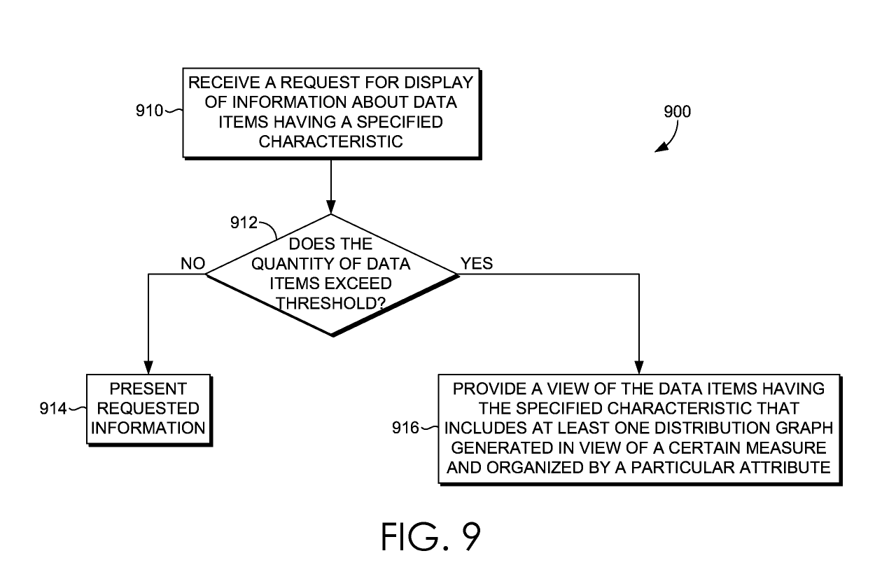

Turning now to FIG. 9, a flow diagram is illustrated showing an exemplary method 900 for providing access to data, in accordance with an embodiment of the present invention. As indicated at block 910, a request for display of information about a plurality of data items is received (e.g., from the request receiving component 220 of the server 212 of FIG. 2), each of the plurality of data items having a specified characteristic. By way of example only, the data corpus may be associated with a retail establishment or a plurality of retail establishments and include information regarding orders, inventories, and the like. In this example, the request for information about a subset of the data items having a specified characteristic may include a request for information about a subset of the data items bearing a particular brand name.

As indicated at block 912, it is determined whether a quantity of the plurality of data items having the specified characteristic exceeds a threshold number, for instance, via the data item determining component 322 and the threshold comparing component 324 of the server 312 of FIG. 3. In embodiments, the threshold number is preconfigured at a number at or above which processing constraints make the presentation of requested detailed information difficult or impractical. By way of example only, the preconfigured threshold number may be 5,000 data items.

If it is determined at block 912 that the quantity of the data items comprising the subset having the specified characteristic does not exceed the threshold number, the requested information is provided, for instance, utilizing the display generating component 328 of the server 312 of FIG. 3. This is indicated at block 914. If, however, it is determined at block 912 that the quantity of the plurality of data items having the specified characteristic exceeds the threshold number, a view of the plurality of data items having the specified characteristic is provided (for instance, utilizing the display generating component 328 of the server 312 of FIG. 3) that includes at least one distribution graph generated in view of a certain measure and showing a visual representation of the plurality of data items having the specified characteristic organized by a particular attribute. This is indicated at block 916. By way of example only, and in continuing with the above example, a view may be provided showing a plurality of distribution graphs illustrating the distribution of data items that are associated with the particular brand name (the specified characteristic) generated in view of inventory (the measure in view of which the graphs are generated), each graph showing a visual representation of those satisfying data items organized by attributes such as retail store location, item number, item descriptor, color, and the like.

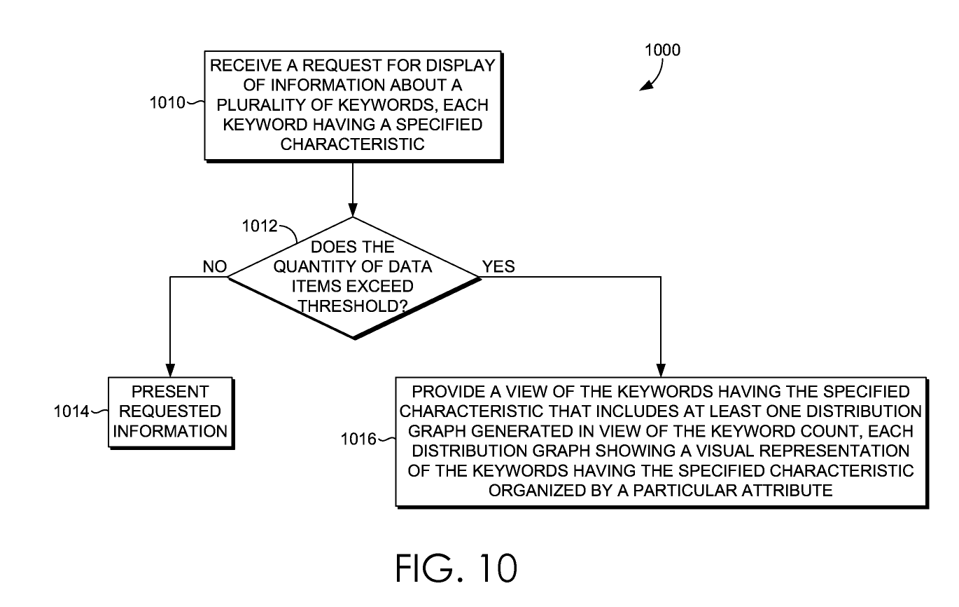

With reference now to FIG. 10, a flow diagram is illustrated showing an exemplary method 1000 for providing access to a subset of online advertising data as an example of a large data corpus, in accordance with an embodiment of the present invention. As indicated at block 1010, a request for display of information about a plurality of keywords, each of the plurality of keywords having a specified characteristic, is received, for instance, by the request receiving component 320 of the server 312 of FIG. 3. It is then determined whether a quantity of the plurality of keywords having the specified characteristic exceeds a threshold number (for instance, utilizing the data item determining component 322 and the threshold comparing component 324 of the server 312 of FIG. 3), as indicated at block 1012. If it is determined that the quantity of the plurality of keywords having the specified characteristic does not exceed the threshold number, the requested information is provided, for instance, utilizing the display generating component 328 of the server 312 of FIG. 3. This is indicated at block 1014. If, however, it is determined at block 1012 that the quantity of the plurality of keywords having the specified characteristic exceeds the threshold number, a view of the plurality of keywords having the specified characteristic is provided (for instance, utilizing the display generating component 328 of the server 312 of FIG. 3) that includes at least one distribution graph generated in view of the keyword count and showing a visual representation of the plurality of keywords having the specified characteristic organized by a particular attribute. This is indicated at block 1016.

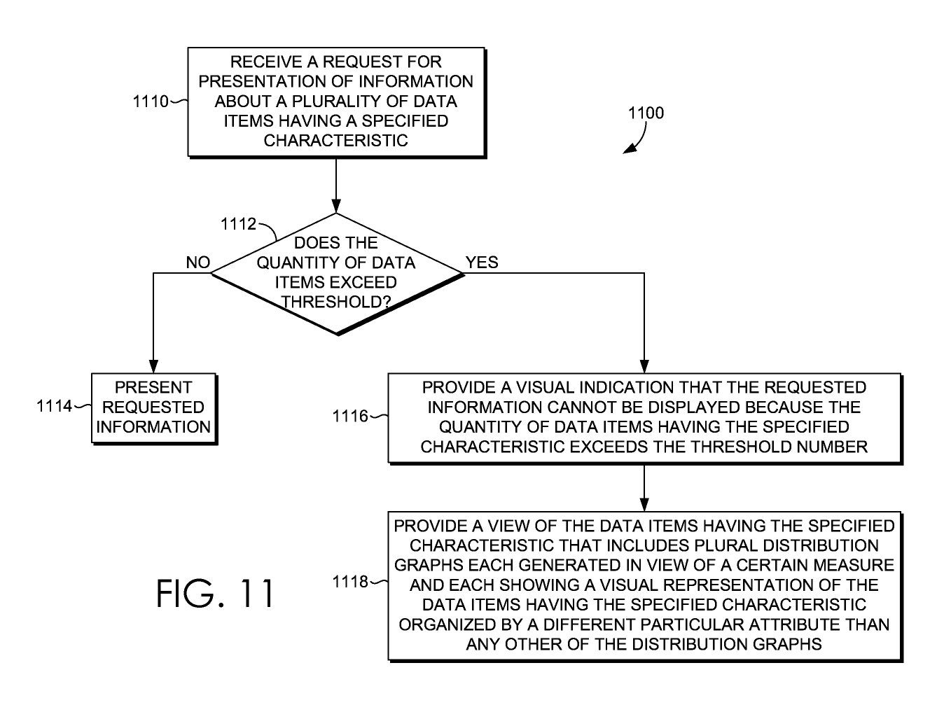

Turning to FIG. 11, a flow diagram is illustrated showing another exemplary method 1100 for providing access to a subset data items included in a large data corpus, the data items comprising the subset each having a specified characteristic, in accordance with an embodiment of the present invention. As indicated at block 1110, a request for presentation of information about a plurality of data items is received, each of the plurality of data items having a specified characteristic. Such request may be received, for instance, by the request receiving component 320 of the server 312 of FIG. 3. As indicated at block 1112, it is determined whether a quantity of the plurality of data items having the specified characteristic exceeds a threshold number, for instance, utilizing the data item determining component 322 and the threshold comparing component 324 of the server 312 of FIG. 3.

If it is determined at block 1112 that the quantity of the data items comprising the subset having the specified characteristic does not exceed the threshold number, the requested information is provided, for instance, utilizing the display generating component 328 of the server 312 of FIG. 3. This is indicated at block 1114. If, however, it is determined at block 1112 that the quantity of the plurality of data items having the specified characteristic exceeds the threshold number, a view of the plurality of data items having the specified characteristic is provided (for instance, utilizing the display generating component 328 of the server 312 of FIG. 3) that includes a visual indication that the requested information cannot be displayed because the quantity of the plurality of data items having the specified characteristic exceeds the threshold number. This is indicated at block 1116. The provided view further includes at least one distribution graph generated in view of a certain measure and showing a visual representation of the plurality of data items having the specified characteristic organized by a particular attribute. This is indicated at block 1118.

As can be understood, embodiments of the present invention provide systems, methods, and computer-readable storage media for, among other things, providing a meaningful view into a corpus of data when the number of data items that make up the corpus is very large. A request for display of information about a subset of data items contained within the corpus that have a specified characteristic is received. A quantity of data items comprising the subset is determined. It also is determined whether the quantity exceeds a threshold number. If the quantity does not exceed the threshold, the requested information is presented. If, however, it is determined that the quantity of data items comprising the subset exceeds the threshold, a view of the data items comprising the subset is provided that includes at least one distribution graph generated in view of a certain measure, each distribution graph showing a visual representation of the data items comprising the subset organized by a particular attribute.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 900 of FIG. 9, 1000 of FIGS. 10, and 1100 of FIG. 11 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for providing access to data, the method comprising:
receiving a request for display of information about a plurality of data items, each of the plurality of data items having a specified characteristic;
determining that a quantity of the plurality of data items having the specified characteristic exceeds a threshold number; and
providing a view of the plurality of data items having the specified characteristic that includes at least one distribution graph generated in view of a certain measure, the at least one distribution graph showing a visual representation of the plurality of data items having the specified characteristic organized by a particular attribute.

2. The one or more computer-readable storage media of claim 1, wherein the method further comprises providing a visual indication that the requested information cannot be displayed because the quantity of the plurality of data items having the specified characteristic exceeds the threshold number.

3. The one or more computer-readable storage media of claim 1, wherein providing the view of the plurality of data items having the specified characteristic includes providing the view with a plurality of distribution graphs, each distribution graph generated in view of the certain measure, and each distribution graph being organized by a different particular attribute than any other of the plurality of distribution graphs.

4. The one or more computer-readable storage media of claim 3, wherein the method further comprises:
receiving an interaction with one of the plurality of distribution graphs; and
altering each of the plurality of distribution graphs that is affected by the interaction to create altered distribution graphs.

5. The one or more computer-readable storage media of claim 4, wherein altering each of the plurality of distribution graphs that is affected by the interaction comprises altering each of the plurality of distribution graphs that is affected by the interaction such that both an altered state and a pre-altered state of the altered distribution graphs is visible.

6. The one or more computer-readable storage media of claim 3, wherein the method further comprises:
receiving an interaction with one of the plurality of distribution graphs, the interaction defining a quantity of the plurality of data items having the specified characteristic that is below the threshold number; and
providing the requested information about the quantity of the plurality of data items having the specified characteristic.

7. A method being performed by one or more computing devices including at least one processor, the method for providing access to online advertising data, the method comprising:
receiving a request for display of information about a plurality of keywords, each of the plurality of keywords having a specified characteristic;
determining that a quantity of the plurality of keywords having the specified characteristic exceeds a threshold number; and
providing a view of the plurality of keywords having the specified characteristic that includes at least one distribution graph generated in view of keyword count, the at least one distribution graph showing a visual representation of the plurality of keywords having the specified characteristic organized by a particular attribute.

8. The method of claim 7, wherein each of the plurality of keywords having the specified characteristic is part of a particular advertising account.

9. The method of claim 7, further comprising providing a visual indication that the requested information cannot be displayed because the quantity of the plurality of keywords having the specified characteristic exceeds the threshold number.

10. The method of claim 7, wherein providing the view of the plurality of keywords having the specified characteristic includes providing the view with a plurality of distribution graphs, each distribution graph generated in view of keyword count, and each distribution graph being organized by a different particular attribute than any other of the plurality of distribution graphs.

11. The method of claim 10, wherein each different particular attribute is one of an identity of an advertising campaign, a keyword status, an advertising group, a keyword click number, a keyword age, a keyword quality score, a number of impressions, and a number of conversions.

12. The method of claim 11, wherein at least one of the different particular attributes is the keyword click number, and wherein the keyword click number has associated therewith a first value representing zero keyword clicks and a second value representing one or more keyword clicks.

13. The method of claim 10, further comprising:
receiving an interaction with one of the plurality of distribution graphs; and
altering each of the plurality of distribution graphs that is affected by the interaction to create altered distribution graphs.

14. The method of claim 13, wherein altering each of the plurality of distribution graphs that is affected by the interaction comprises altering each of the plurality of distribution graphs that is affected by the interaction such that both an altered state and a pre-altered state of the altered distribution graphs is visible.

15. The method of claim 10, wherein the method further comprises:
receiving an interaction with one of the plurality of distribution graphs, the interaction defining a quantity of the plurality of keywords having the specified characteristic that is below the threshold number; and
providing the requested information about the quantity of the plurality of keywords having the specified characteristic.

16. A system comprising:
a server having one or more processors and one or more computer-readable storage media;
a data store coupled with the server,
wherein the server:
receives a request for presentation of information about a plurality of data items, each of the plurality of data items having a specified characteristic;
determines that a quantity of the plurality of data items having the specified characteristic exceeds a threshold number;
provides a visual indication that the requested detailed information cannot be displayed because the number of the plurality of data items having the specified characteristic exceeds the threshold number; and
provides a view of the plurality of data items having the specified characteristic that includes plural distribution graphs each generated in view of a certain measure and each showing a visual representation of the plurality of data items having the specified characteristic organized by a different particular attribute than any other of the plurality of distribution graphs.

17. The system of claim 16, wherein the server further:
receives an interaction with one of the plurality of distribution graphs; and
alters each of the plurality of distribution graphs that is affected by the interaction to create altered distribution graphs.

18. The system of claim 17, wherein the server alters each of the plurality of distribution graphs that is affected by the interaction such that both an altered state and a pre-altered state of the altered distribution graphs is visible.

19. The system of claim 16, wherein the server further:
receives an interaction with one of the plurality of distribution graphs, the interaction defining a quantity of the plurality of data items having the specified characteristic that is below the threshold number; and
provides the requested information about the quantity of the plurality of data items having the specified characteristic.

20. The system of claim 16, wherein each of the plurality of data items is a keyword, and wherein each keyword is part of a particular advertising account.
